(19) United States
(12) Patent Application Publication
(10) Pub. No.: US 2025/0026159 A1
(43) Pub. Date: Jan. 23, 2025

(54) Method for detecting that a vehicle is running

(71) Applicant: Continental Automotive Technologies GmbH, Hannover (DE)

(72) Inventors: Vincent CHEVALLIER, Plaisance du Touch (FR); Jean-Philippe BOISSET, MONTAUBAN (FR); Frédéric LATHIERE, TOULOUSE (FR)

(73) Assignee: Continental Automotive Technologies GmbH, Hannover (DE)

(21) Appl. No.: 18/751,580

(22) Filed: Jun. 24, 2024

(30) Foreign Application Priority Data
Jul. 21, 2023 (FR) 2307850

(51) Int. Cl. B60C 23/04; G01P 13/00

(52) U.S. Cl. CPC B60C 23/0488; G01P 13/00

(57) ABSTRACT

A method for detecting a rotational movement of a body about an axis of rotation with respect to a fixed structure. The body including a sensor to carry out measurements on the body and having a first radiofrequency transceiver to communicate with a second radiofrequency transceiver provided on an electronic computer mounted on the fixed structure by a Bluetooth® Low Energy communication link to transmit the measurements to the electronic computer. The sensor being able to transmit radiofrequency signals and the electronic computer being capable of confirming receipt of the radiofrequency signals by transmitting a response signal to the sensor. The method includes detecting the rotational movement of the body by the sensor by the response signals transmitted by the electronic computer and adapting the periodicity of the radiofrequency signals transmitted by the sensor as a function of the rotation or non-rotation of the body.

### CROSS REFERENCE TO RELATED APPLICATION

This application claims priority to French Application No. 2307850, filed Jul. 21, 2023, the contents of such application being incorporated by reference herein.

### FIELD OF THE INVENTION

The present invention relates to a method for detecting that a motor vehicle is running by means of a system for monitoring the pressure of the tires of said vehicle.

### BACKGROUND OF THE INVENTION

Motor vehicle safety legislation requires manufacturers to provide means for monitoring the pressure of vehicle tires.

To this end, multiple pressure monitoring systems have been developed and put on the market in recent years.

As is known per se, these pressure monitoring systems, commonly designated “TPMS” (for “tire pressure monitoring system”), typically comprise at least one wheel unit (comprising at least one pressure sensor) disposed inside the chamber defined by the tire and the rim of the wheel of a vehicle, and remote calculation means that have a one-way or two-way radiofrequency communication link with this wheel unit, these calculation means generally being located in the electronic computer of an onboard central electronic unit of the vehicle (commonly designated “ECU” for “electronic control unit”).

The wheel unit and the ECU communicate via a radiofrequency communication network. The wheel unit comprises a transmitter and the ECU comprises a receiver.

A radiofrequency frame, generally referred to as “RF frame”, is transmitted by the wheel unit and received by the ECU in order to transmit wheel pressure parameters.

The radiofrequency communication is performed in Bluetooth® Low Energy (commonly designated “BLE”), enabling the short-range two-way exchange of data using UHF radio waves on the 2.4 GHz frequency band.

The advantage of Bluetooth® Low Energy over “conventional” Bluetooth® is that it makes it possible to send a small amount of data while consuming very little energy.

The wheel unit may be fixed inside the tread of the tire, or to the inflation valve of this tire, which inflation valve is mounted inside an orifice formed on the rim.

The wheel unit of the tire is typically supplied with power by a non-rechargeable battery which can have a service life of ten years, for example.

It is known to use an accelerometer, an impact sensor, or a sensor sensing the Earth's magnetic field, in the pressure monitoring systems for detecting that the vehicle is running. This detection that a vehicle is running makes it possible to optimize the consumption of the wheel unit by limiting the number of times radiofrequency frames are transmitted when the vehicle is at a standstill (“parking” mode). This makes it possible to reduce the energy consumption of the wheel unit in order to extend the service life of the battery.

However, the addition of an accelerometer, an impact sensor, or a sensor for sensing the Earth's magnetic field increases the complexity, the weight and the cost of the wheel units of the pressure monitoring system.

This also results in more product references to be managed.

### SUMMARY OF THE INVENTION

An aspect of the invention solves this problem by proposing a method for detecting the rotation of a body, notably a wheel of a motor vehicle, that makes it possible to reduce the complexity and the weight of the wheel units of the pressure monitoring system by reducing the number of its components.

An aspect of the invention relates to a method for detecting a rotational movement of a body about an axis of rotation with respect to a fixed structure. The body comprises a sensor intended to carry out measurements on the body and has a first radiofrequency transceiver intended to communicate with a second radiofrequency transceiver provided on an electronic computer mounted on the fixed structure by means of a Bluetooth® Low Energy communication link to transmit the measurements to the electronic computer. The sensor is capable of periodically transmitting radiofrequency signals and the electronic computer is capable of confirming receipt of the radiofrequency signals by transmitting a radiofrequency response signal to the sensor.

According to an aspect of the invention, the detection method comprises a step of detecting the rotational movement of the body by the sensor by means of the response signals transmitted by the electronic computer and a step of adapting the periodicity of the radiofrequency signals transmitted by the sensor as a function of the rotation or non-rotation of the body.

An aspect of the invention thus provides a method for detecting the rotation of a body, notably a wheel of a motor vehicle, that makes it possible to reduce the complexity and the weight of the pressure monitoring system by reducing the number of its components.

There are also fewer product references to be managed.

An aspect of the invention also makes it possible to reduce the energy consumption of the sensor and to extend the service life of the battery.

In a variant, during the step of adapting the periodicity of the signals transmitted, the sensor transmits periodic radiofrequency frames intended to be received by the electronic computer at a first periodicity P1 when the body is not rotating. The sensor transmits periodic radiofrequency frames at a second periodicity P2 when the body is rotating, with P2 being strictly greater than P1.

In a variant, during the step of detecting the rotational movement of the body, the sensor measures the intensity of the response signal transmitted by the electronic computer. The body is considered to be rotating if a variation between two successive radiofrequency response signals is detected, otherwise the body is considered to be stationary.

In a variant, the variation in intensity between two successive radiofrequency response signals is considered to be significant if a detection threshold, taking a margin of error into account, is reached.

This makes it possible to compare two successive radiofrequency response signals with a margin of error, taking into account the accuracy of the measurement, the surrounding noise, a vehicle which is parked close by, the fluctuation between the Bluetooth Low Energy channels, for example.

In a variant, multiple measurements are averaged to filter the radiofrequency signals.

This makes it possible to take account of the fact that, in “parking” mode, two successive radiofrequency response signals may be different.

In a variant, after detection of the rotation of the body, the sensor transmits radiofrequency frames at the second periodicity P2. The electronic computer confirms receipt of the radiofrequency frames of period P2 by transmitting a response signal to the sensor. The sensor measures the intensity of a succession of response signals transmitted by the electronic computer to determine a shape of the signals. It is confirmed that the body is rotating when the shape of the signals is periodic. Otherwise, the wheel is considered to be stationary if the shape of the signals is not periodic.

This makes it possible to make the method more reliable and ensure that the body is indeed rotating.

In a variant, during the step of detecting the rotational movement of the body, the sensor transmits radiofrequency frames, the rotation of the body being detected if the electronic computer confirms receipt of the radiofrequency frames by transmitting a response signal to the sensor. The sensor transmits radiofrequency frames at the second periodicity P2.

This variant provides a simpler method. If the electronic computer activates, it means that the body is rotating.

In a variant, the step of detecting the rotational movement of the body is performed using a sensor in “advertising” mode, in which periodic signals of short duration are transmitted by the sensor so as to permit a connection to the electronic computer.

In a variant, the detection method is a method for detecting that a motor vehicle is running, comprising a pressure monitoring system intended to measure the pressure in a tire of a wheel of the vehicle. The wheel comprises a wheel unit capable of establishing a Bluetooth® Low Energy communication link for transmitting pressure measurements to an electronic computer of a central electronic unit of the vehicle.

An aspect of the invention also relates to a motor vehicle implementing the detection method as defined above.

### BRIEF DESCRIPTION OF THE DRAWINGS

FIG. 1 shows a diagram of a method for detecting the rotation of a vehicle wheel, according to a first embodiment of the invention;

FIG. 2 shows a diagram of a method for detecting the rotation of a vehicle wheel, according to a second embodiment of the invention.

### DETAILED DESCRIPTION OF EXEMPLARY EMBODIMENTS

An aspect of the invention relates to a method for detecting a rotational movement of a body about an axis of rotation with respect to a fixed structure, and more particularly of a vehicle wheel, to determine if the vehicle is running or at a standstill (“parking mode”).

The example below is given for a pressure monitoring system associated with a wheel of a vehicle but may also be applied to other monitoring or measuring systems associated with a rotating body that uses a Bluetooth® Low Energy communication link.

The vehicle comprises a pressure monitoring system which is commonly designated “TPMS” (tire pressure monitoring system) and typically comprises at least one wheel unit, which comprises a pressure sensor and is disposed inside the chamber defined by the tire and the rim of the wheel of the vehicle, and remote calculation means that have a two-way radiofrequency communication link with this wheel unit, these calculation means generally being located in the electronic computer of an onboard central electronic unit of the vehicle (commonly designated “ECU” for “electronic control unit”).

The wheel unit may be fixed inside the tread of the tire, or to the inflation valve of this tire, which inflation valve is mounted inside an orifice formed on the rim.

The wheel unit of the tire is typically supplied with power by a non-rechargeable battery which can have a service life of ten years, for example.

The wheel unit and the central electronic unit communicate via a radiofrequency communication network. The wheel unit comprises a first radiofrequency transceiver assembly and the central electronic unit comprises a second radiofrequency transceiver assembly.

A radiofrequency frame, generally referred to as “RF frame”, is transmitted by the wheel unit and received by the central electronic unit in order to transmit wheel pressure parameters.

The radiofrequency communication is performed in Bluetooth® Low Energy (commonly designated “BLE”), enabling the short-range two-way exchange of data using UHF radio waves on the 2.4 GHz frequency band.

The wheel unit operates in two communication modes, namely an “advertising” mode in which periodic signals of short duration are transmitted by the wheel unit to permit a connection to the central electronic unit and a “connected” mode in which a stable connection is established between the wheel unit and the central electronic unit to transmit pressure measurements.

In the “advertising” communication mode, a two-way communication link is established between the wheel unit and the central electronic unit. The central electronic unit acknowledges the periodic signals by transmitting a frame of radiofrequency signals to the wheel unit. In other words, the central electronic unit confirms that it has received the received signal properly by returning a specific radiofrequency frame to the wheel unit. This operation of transmitting frames of radiofrequency signals is commonly designated by the term “scan request”.

The “advertising” mode is used first of all to attempt to establish a radiofrequency connection to the central electronic unit and possibly change to the “connected” mode, which makes it possible to exchange pressure information via radiofrequency frames between the wheel unit and the central electronic unit.

The “connected” mode is optional.

The transmission power of the wheel unit is fixed and increased to ensure successful radiofrequency reception by the central electronic unit.

When the vehicle is started up, the central electronic unit analyzes or scans its surrounding area to attempt to connect to the wheel unit. When the central electronic unit picks up a signal transmitted by the wheel unit, it accepts (or acknowledges) this signal and notifies the wheel unit of this. More particularly, the wheel unit sends radiofrequency frames.

According to an aspect of the invention, the method for detecting the rotation of the wheel of the vehicle comprises a step of detecting the rotational movement of the wheel by the wheel unit by means of the radiofrequency signals transmitted by the central electronic unit and received by the wheel unit and a step of adapting the periodicity of the radiofrequency signals transmitted by the wheel unit as a function of the movement of the wheel, which is to say the rotation or non-rotation of the wheel.

During the step of adapting the periodicity of the signals transmitted, the wheel unit transmits periodic radiofrequency frames intended to be received by the central electronic unit at a first periodicity P1 when the wheel is not rotating. The wheel unit transmits periodic radiofrequency frames at a second periodicity P2 when the wheel is rotating, with P2 being strictly greater than P1. This makes it possible to save energy when the vehicle is parked.

According to a first embodiment of the invention, during the step of detecting the rotational movement of the wheel, the wheel unit transmits radiofrequency frames and the central electronic unit confirms receipt of (or acknowledges) the radiofrequency frames by transmitting a response signal to the wheel unit.

The wheel unit measures the intensity of the response signal transmitted by the central electronic unit. The wheel on which the wheel unit is mounted is considered to be rotating if a variation in intensity between two successive radiofrequency response signals is detected, otherwise the wheel is considered to be stationary. More specifically, this is the variation in the received signal strength indication (RSSI) which is analyzed by the wheel unit. The received signal strength indication is available since it is imposed by the Bluetooth® Low Energy standard.

The wheel unit rotates, receives radiofrequency response signals at different angles of the wheel, with a changing radiofrequency link budget, this not being the case when the vehicle is in “parking” mode.

It is thus considered that the wheel is stationary and the vehicle is in “parking” mode if the variation between two successive radiofrequency response signals is not significant, which is to say if the signals exhibit identical or virtually identical intensities, taking a margin of error into account. It is considered that the wheel is rotating and the vehicle is running if the variation between two successive response signals is significant. It is, in fact, the intensity of the electromagnetic field of the radiofrequency signal received by the wheel unit that is measured. The wheel unit analyzes the level of radiofrequency power it receives.

To deduce that the wheel is stationary from this, the comparison between two successive radiofrequency response signals is performed with a margin of error, taking into account the accuracy of the measurement, the surrounding noise, a vehicle which is parked close by, the fluctuation between the Bluetooth® Low Energy channels, for example.

A detection threshold may be applied. A variation in intensity is then detected if this detection threshold is reached, in other words if the difference between two successive radiofrequency response signals is high enough, taking into account the above parameters that can disrupt the radiofrequency signal and cause it to vary.

If the variation between two successive response signals is less than this detection threshold, the wheel is considered to be stationary.

In a variant, given that in “parking” mode, two successive radiofrequency response signals may be different, it is possible to average multiple measurements at a determined period, that is to say at a wheel angle which is identical between each measurement, to make it possible to filter the signal.

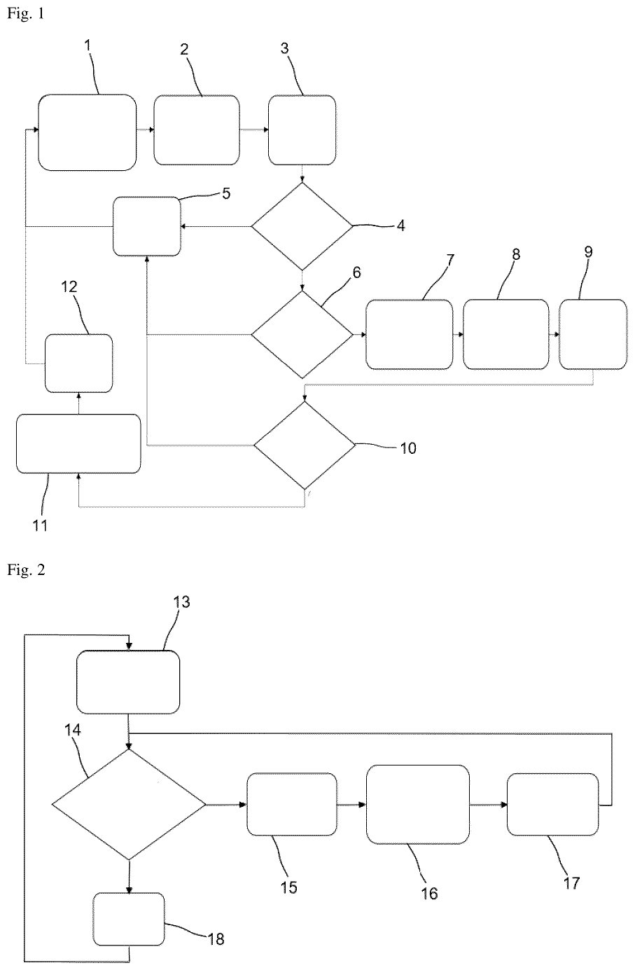

According to the diagram in FIG. 1, which illustrates an example, the detection method comprises a first step 1 during which the wheel unit transmits radiofrequency frames and a second step 2 during which the central electronic unit confirms receipt of the radiofrequency frames by transmitting a response signal to the wheel unit, irrespective of the communication mode (“advertising” mode or “connected” mode).

The detection method comprises a third step 3 during which the wheel unit measures the intensity or the power of the response signal transmitted by the central electronic unit.

As per a first result (step referenced 4), it is considered that the wheel is stationary and the vehicle is in “parking” mode (step referenced 5) if the variation between two successive response signals is not significant, taking the margin of error into account.

As per a second result (step referenced 6), it is considered that the wheel is rotating and the vehicle is running if the variation between two successive response signals is significant and exceeds a detection threshold.

The detection method comprises a fourth step 7 during which the wheel unit transmits radiofrequency frames at the second periodicity P2, which is to say that it increases the periodicity of the radiofrequency frames.

The detection method comprises a fifth step 8 during which the central electronic unit confirms receipt of (acknowledges) the radiofrequency frames of period P2 by transmitting a response signal to the wheel unit.

The detection method comprises a sixth step 9 during which the wheel unit measures the intensity of a succession of response signals transmitted by the central electronic unit to determine the shape of the signals. It is confirmed that the wheel is rotating and therefore the vehicle is running when the shape of the signals is periodic. In other words, the wheel unit analyzes the level of radiofrequency power that it receives and identifies a (periodic) footprint, which is a signature for a relative rotation of the wheel.

With preference, it is confirmed that the wheel is rotating and therefore the vehicle is running when the shape of the signals is sinusoidal.

The rotation of the wheel and therefore the running of the vehicle are schematically shown by result 10 in the diagram.

If the shape of the signals is not periodic, it is considered that the wheel is stationary and the vehicle is in “parking” mode (step referenced 5).

The detection method comprises a seventh step 11 during which the central electronic unit switches to the running mode. The internal modes of the wheel unit are modified in order to optimize notably its electricity consumption.

A time delay step 12 may be added before the method loops back to the first step 1.

According to a second embodiment of the invention, during the step of detecting the rotational movement of the wheel, the wheel unit transmits radiofrequency frames, the rotation of the wheel being detected if the central electronic unit confirms receipt of the radiofrequency frames by transmitting a response signal to the wheel unit.

If the vehicle was initially stationary, the wheel unit would transmit radiofrequency frames at the first periodicity P1. The wheel unit increases the periodicity of the radiofrequency frames to the second periodicity P2 when the central electronic unit is activated.

By contrast, if the vehicle was initially running, the wheel unit would transmit radiofrequency frames at the second periodicity P2. The wheel unit decreases the periodicity of the radiofrequency frames to the first periodicity P1 when the central electronic unit becomes inactive.

In fact, when the vehicle is at a standstill, the central electronic unit is turned off. When the vehicle starts to run, the central electronic unit is turned on and starts to respond to the wheel unit. This response allows the wheel unit to detect that the vehicle is running.

According to the diagram in FIG. 2, the detection method comprises a first step 13 during which the wheel unit transmits radiofrequency frames at the low periodicity P1 when the vehicle is stationary (“parking” mode).

The detection method comprises a second step 14 of determining the movement of the vehicle. If the vehicle is running, the central electronic unit confirms receipt of the radiofrequency frames from the wheel unit by transmitting a response signal to the wheel unit during a fourth step 15.

The wheel unit detects the response signal during a fifth step 16 and switches to the running mode.

The periodicity of the radiofrequency frames is increased to the second periodicity P2 during a sixth step 17.

If the vehicle is stationary, a delay is applied during a seventh step 18 before the method loops back to the first step 13.

1. A method for detecting a rotational movement of a body about an axis of rotation with respect to a fixed structure, the body comprising a sensor intended to carry out measurements on the body and having a first radiofrequency transceiver intended to communicate with a second radiofrequency transceiver provided on an electronic computer mounted on the fixed structure by a Bluetooth® Low Energy communication link to transmit the measurements to the electronic computer, the sensor being capable of periodically transmitting radiofrequency signals and the electronic computer being capable of confirming receipt of the radiofrequency signals by transmitting a radiofrequency response signal to the sensor, the method comprising:
detecting the rotational movement of the body by the sensor by the response signals transmitted by the electronic computer; and
adapting the periodicity of the radiofrequency signals transmitted by the sensor as a function of the rotation or non-rotation of the body.

2. The detection method as claimed in claim 1, wherein, during the step of adapting the periodicity of the signals transmitted, the sensor transmits periodic radiofrequency frames intended to be received by the electronic computer at a first periodicity P1 when the body is not rotating, the sensor transmitting periodic radiofrequency frames at a second periodicity P2 when the body is rotating, with P2 being strictly greater than P1.

3. The detection method as claimed in claim 1, wherein, during the step of detecting the rotational movement of the body, the sensor measures the intensity of the response signal transmitted by the electronic computer, the body being considered to be rotating if a variation in intensity between two successive radiofrequency response signals is detected, otherwise the body is considered to be stationary.

4. The detection method as claimed in claim 3, wherein the variation in intensity between two successive radiofrequency response signals is considered to be significant if a detection threshold, taking a margin of error into account, is reached.

5. The detection method as claimed in claim 3, wherein multiple measurements are averaged to filter the radiofrequency signals.

6. The detection method as claimed in claim 3. wherein, after detection of the rotation of the body, the sensor transmits radiofrequency frames at the second periodicity P2, the electronic computer confirming receipt of the radiofrequency frames of period P2 by transmitting a response signal to the sensor, the sensor measuring the intensity of a succession of response signals transmitted by the electronic computer to determine a shape of the signals, it being confirmed that the body is rotating when the shape of the signals is periodic, otherwise the wheel is considered to be stationary if the shape of the signals is not periodic.

7. The detection method as claimed in claim 2, wherein, during the step of detecting the rotational movement of the body, the sensor transmits radiofrequency frames, the rotation of the body being detected if the electronic computer confirms receipt of the radiofrequency frames by transmitting a response signal to the sensor, the sensor transmitting radiofrequency frames at the second periodicity P2.

8. The detection method as claimed in claim 7, wherein the step of detecting the rotational movement of the body is performed using a sensor in “advertising” mode, in which periodic signals of short duration are transmitted by the sensor so as to permit a connection to the electronic computer.

9. The detection method as claimed in claim 1, wherein the detection method is a method for detecting that a motor vehicle is running, comprising a pressure monitoring system intended to measure the pressure in a tire of a wheel of the vehicle, the wheel comprising a wheel unit capable of establishing a Bluetooth® Low Energy communication link for transmitting pressure measurements to an electronic computer of a central electronic unit of the vehicle.

10. A motor vehicle, implementing the method for detecting a rotational movement of a body as defined in claim 1.

11. The detection method as claimed in claim 2, wherein, during the step of detecting the rotational movement of the body, the sensor measures the intensity of the response signal transmitted by the electronic computer, the body being considered to be rotating if a variation in intensity between two successive radiofrequency response signals is detected, otherwise the body is considered to be stationary.
